(19) United States
(12) Patent Application Publication
(10) Pub. No.: US 2025/0081009 A1
(43) Pub. Date: Mar. 6, 2025

(54) COMMUNICATION METHOD AND COMMUNICATION APPARATUS

(71) Applicant: BEIJING XIAOMI MOBILE SOFTWARE CO., LTD, Beijing (CN)

(72) Inventor: Xiandong DONG, Beijing (CN)

(73) Assignee: BEIJING XIAOMI MOBILE SOFTWARE CO., LTD, Beijing (CN)

(21) Appl. No.: 18/726,947

(22) PCT Filed: Jan. 6, 2022
(86) PCT No.: PCT/CN2022/070594

§ 371 Date: Jul. 5, 2024

(51) Int. Cl. H04W 24/08; H04W 84/12

(52) U.S. Cl. CPC H04W 24/08; H04W 84/12

(57) ABSTRACT

Provided in the present disclosure are a communication method and a communication apparatus. The communication method may comprise: sending a null data packet announcement (NDPA) frame; sending an uplink null data packet (NDP) frame; and receiving a downlink NDP frame, wherein one of the uplink NDP frame and the downlink NDP frame is a measurement NDP frame used for wireless local area network sensing measurement, the other one of the uplink NDP frame and the downlink NDP frame is a non-measurement NDP frame which is not used for wireless local area network sensing measurement, and the measurement NDP frame and the non-measurement NDP frame have different operation parameters or formats.

### CROSS-REFERENCE TO RELATED APPLICATIONS

This application is a national stage of international application No. PCT/CN2022/070594, filed on Jan. 6, 2022, content of which is hereby incorporated by reference in its entirety.

### TECHNICAL FIELD

The present disclosure relates to the field of wireless communication, and in particular, to a communication method and a communication apparatus for a wireless local area network (WLAN).

### BACKGROUND

WLAN has characteristics of flexibility, mobility and low cost. With development of communication technologies and growth of user demands, application research on WLAN is gradually deepened. For example, WLAN sensing is currently being studied, and its main application scenarios are: location discovery (home environment and enterprise environment), proximity detection, and presence detection in a dense environment.

### SUMMARY

Embodiments of the present disclosure provide the following technical solutions.

An exemplary embodiment according to the present disclosure provides a communication method. The communication method may include: sending a null data packet announcement (NDPA) frame; sending an uplink null data packet (NDP) frame; and receiving a downlink NDP frame, where one of the uplink NDP frame and the downlink NDP frame is a measurement NDP frame used for wireless local area network sensing measurement, and another of the uplink NDP frame and the downlink NDP frame is a non-measurement NDP frame not used for the wireless local area network sensing measurement, and the measurement NDP frame and the non-measurement NDP frame are of different operation parameters or formats.

An exemplary embodiment according to the present disclosure provides a communication method. The communication method may include: receiving a null data packet announcement (NDPA) frame; receiving an uplink null data packet (NDP) frame; and sending a downlink NDP frame, where one of the uplink NDP frame and the downlink NDP frame is a measurement NDP frame used for wireless local area network sensing measurement, and another of the uplink NDP frame and the downlink NDP frame is a non-measurement NDP frame not used for the wireless local area network sensing measurement, and the measurement NDP frame and the non-measurement NDP frame are of different operation parameters or formats.

An exemplary embodiment according to the present disclosure provides a communication apparatus. The communication apparatus may include: a transceiving module, configured to: send an NDPA frame; send an uplink NDP frame; and receive a downlink NDP frame. One of the uplink NDP frame and the downlink NDP frame is a measurement NDP frame used for wireless local area network sensing measurement, and another of the uplink NDP frame and the downlink NDP frame is a non-measurement NDP frame not used for the wireless local area network sensing measurement, and the measurement NDP frame and the non-measurement NDP frame are of different operation parameters or formats.

An exemplary embodiment according to the present disclosure provides a communication apparatus. The communication apparatus may include: a transceiving module, configured to: receive an NDPA frame; receive an uplink NDP frame; and send a downlink NDP frame. One of the uplink NDP frame and the downlink NDP frame is a measurement NDP frame used for wireless local area network sensing measurement, and another of the uplink NDP frame and the downlink NDP frame is a non-measurement NDP frame not used for the wireless local area network sensing measurement, and the measurement NDP frame and the non-measurement NDP frame are of different operation parameters or formats.

An exemplary embodiment according to the present disclosure provides an electronic device. The electronic device includes a memory, a processor, and a computer program stored on the memory and executable on the processor. When executing the computer program, the processor implements the methods described herein.

An exemplary embodiment according to the present disclosure provides a non-transitory computer-readable storage medium. The non-transitory computer-readable storage medium stores a computer program. When the computer program is executed by a processor, the methods described herein are implemented.

According to the technical solution provided by the embodiments of the present disclosure, an overhead of the NDP frame not used for the WLAN sensing measurement can be saved.

### BRIEF DESCRIPTION OF DRAWINGS

The features of the embodiments of the present disclosure will become more apparent by describing in detail example embodiments of the present disclosure with reference to the accompanying drawings.

FIGS. 1A-1C show an exemplary manner of WLAN sensing.

FIGS. 2A-2C show an application scenario of a Non-TB based sensing manner according to an exemplary embodiment.

FIG. 3 shows a flowchart of a communication method according to an exemplary embodiment.

FIG. 4 shows a flowchart of a communication method performed by an initiator in an uplink sounding according to an exemplary embodiment.

FIG. 5 shows a flowchart of a communication method performed by an initiator in a downlink sounding according to an exemplary embodiment.

FIG. 6 shows a flowchart of another communication method according to an exemplary embodiment.

FIG. 7 shows a flowchart of a communication method performed by a responder in an uplink sounding according to an exemplary embodiment.

FIG. 8 shows a block diagram of a communication apparatus according to an exemplary embodiment.

### DETAILED DESCRIPTION

The following description is provided with reference to the accompanying drawings to assist in a thorough understanding of various embodiments of the disclosure defined by the appended claims and their equivalents. Various embodiments of the present disclosure include various specific details, but these specific details are only considered exemplary. Furthermore, descriptions of well-known techniques, functions, and configurations may be omitted for clarity and brevity.

The terms and words used in the present disclosure are not limited to written meaning, but are only used by the inventors to clearly and consistently understand the present disclosure. Accordingly, the description of various embodiments of the present disclosure will be provided to those skilled in the art for illustrative purposes only and not for limiting purposes.

It should be understood that singular forms “a”, “an”, “the” and “said” used herein may also include plural forms unless the context clearly indicates otherwise. It should be further understood that the phrase “include” as used in this disclosure refers to the presence of described features, integers, steps, operations, elements, and/or components, but does not preclude the presence or addition of one or more other features, integers, steps, operations, elements, components, and/or groups thereof.

It will be understood that although the terms “first”, “second”, etc., may be used herein to describe various elements, these elements should not be limited by these terms. These terms are only used to distinguish one element from another. Thus, a first element discussed below may be referred to as a second element without departing from teachings of the example embodiments.

It should be understood that when an element is referred to as being “connected” or “coupled” to another element, it may be directly connected or coupled to the other element, or intervening elements may also be present. Further, “connected” or “coupled” as used herein may include wireless connections or wireless couplings. As used herein, the term “and/or” or the expression “at least one of” includes any and all combinations of one or more of the related listed items.

Unless otherwise defined, all terms (including technical terms and scientific terms) used herein have same meaning as commonly understood by one of ordinary skill in the art to which this disclosure belongs.

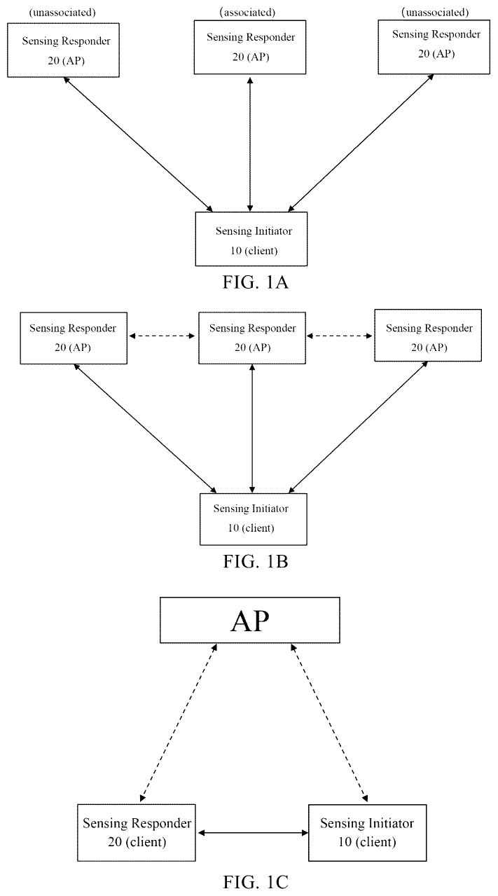

FIGS. 1A-1C show an exemplary manner of WLAN sensing.

A WLAN sensing procedure may include: an initiator initiates WLAN sensing (for example, initiates a WLAN sensing session), and there may be a plurality of responders responding thereto, and specific possible manners may be shown in FIG. 1A, FIG. 1B and FIG. 1C.

Referring to FIG. 1A, when a WLAN sensing initiator 10 (for example, a client) initiates WLAN sensing, a plurality of associated or unassociated WLAN sensing responders 20 (for example, three access points (AP)) may respond. Herein, “associated” may refer to that an associated connection for communication is established between the initiator and the responder, and “non-associated” may refer to that no associated connection for communication is established between the initiator 10 and the responder 20.

As an example, the client (sensing initiator 10) may include, but is not limited to: a cellular phone, a smartphone, a wearable device, a computer, a personal digital assistant (PDA), a personal communication system (PCS) device, a personal information manager (PIM), a personal navigation device (PND), a global positioning system, a multimedia device, an Internet of Things (IoT) device, and the like.

The AP (sensing responder 20) may be a wireless switch for a wireless network or an access device for a wireless network. The AP may include software applications and/or circuits such that other types of nodes in the wireless network may communicate with outside and inside of the wireless network through the AP. As an example, the AP may be a terminal device or a network device equipped with a Wi-Fi (Wireless Fidelity) chip.

FIG. 1B is similar to FIG. 1A, but in FIG. 1B, each responder (AP) 20 may communicate with each other.

Referring to FIG. 1C, both the WLAN sensing initiator 10 and the WLAN sensing responder 20 may be the clients, and both may communicate by connecting to a same AP 20.

Although shown in FIG. 1A, FIG. 1B and FIG. 1C, the client serves as the initiator 10, and the AP serves as the responder 20, the present disclosure is not limited thereto, for example, the AP may serve as the initiator 10, and the client may serve as the responder 20. Furthermore, a number of initiators and responders is not limited to that shown in FIGS. 1A-1C.

As an illustrative embodiment, a WLAN sensing process may include: WLAN sensing session setup, WLAN sensing measurement setup, and WLAN sensing measurement termination. In WLAN sensing session setup, operating parameters associated with the sensing session may be determined and exchanged between devices. In WLAN sensing measurement setup, sensing measurement and/or measurement result reporting may be performed, and thus WLAN sensing measurement setup may also be referred to as WLAN sensing measurement procedure. In WLAN sensing measurement termination, the device stops performing measurements and terminates the sensing session.

In addition, in the WLAN sensing technology, a trigger-based (TB-based) sensing manner and a non-trigger-based (Non-TB based) sensing manner are proposed. For example, in a TB-based sensing manner, the AP may be an initiator 10 or a transmitter, and in a Non-TB-based sensing manner, a station (STA) may be an initiator 10 or a transmitter. An example of a station (STA) may be similar to the example of the client described herein, and repeated descriptions are omitted herein for brevity.

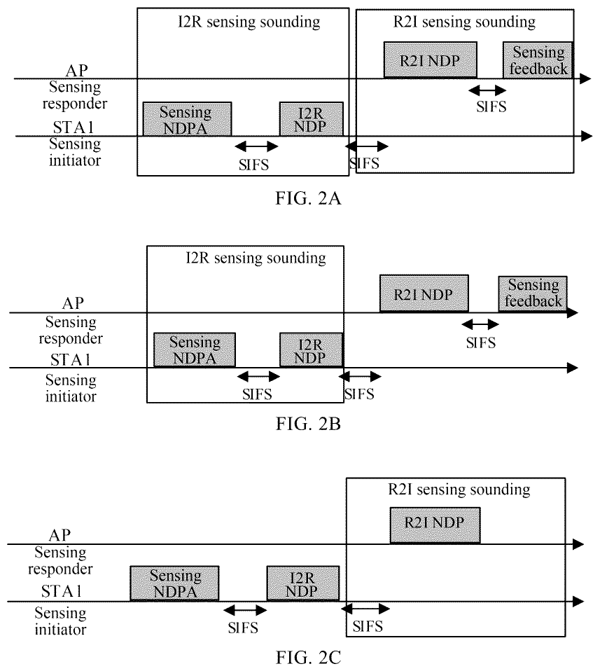

FIG. 2A-2C show three typical application scenarios of a Non-TB based sensing manner according to an exemplary embodiment.

Since the station (STA) (shown as STA1 in FIGS. 2A-2C) serves as an initiator and does not have capability of the AP to communicate with a plurality of users at the same time, in a Non-TB based sensing process, sensing measurement is initiated by the STA, and an uplink sounding (UL sounding) or downlink sounding (DL sounding) process or both may be performed in one sensing measurement.

In FIGS. 2A-2C, I2R may represent “initiator to responder” (i.e., uplink), and R2I may represent “responder to initiator” (i.e., downlink). Therefore, I2R sensing sounding may represent uplink sounding (UL sounding), R2I sensing sounding may represent downlink sounding (DL sounding), and SIFS (Short Interframe Space) may represent a sending interval between frames.

FIG. 2A shows that both uplink sounding and downlink sounding are performed in one sensing measurement, FIG. 2B shows that only uplink sounding is performed, and FIG. 2C shows that only downlink sounding is performed.

In FIG. 2A, an NDPA (Null Data Packet Announcement) frame sent by an initiator indicates that a WLAN sensing channel is obtained, and both an I2R NDP (Null Data Packet) frame and a R2I NDP frame are used for (or participate in) WLAN sensing measurement. However, in FIG. 2B, when only uplink sounding is performed (that is, the initiator sends a I2R NDP frame), the AP also sends a downlink sounding frame (that is, a R2I NDP frame) in the entire measurement process, but the R2I NDP frame is not used for WLAN sensing measurement, but is merely used to identify that the AP receives the NDPA frame and enable the AP to have enough time to prepare sensing feedback. Conversely, in FIG. 2C, when only downlink sounding is performed (that is, the responder sends the R2I NDP frame, and the initiator performs WLAN sensing measurement by using the received R2I NDP frame), the I2R NDP frame sent by the initiator is not used for WLAN sensing measurement, but only for a purpose of protocol integrity.

It is required or desirable to save overhead as much as possible for NDP frames that are not used for WLAN sensing measurements. In view of this, a communication method and a communication apparatus according to embodiments of the present disclosure are provided.

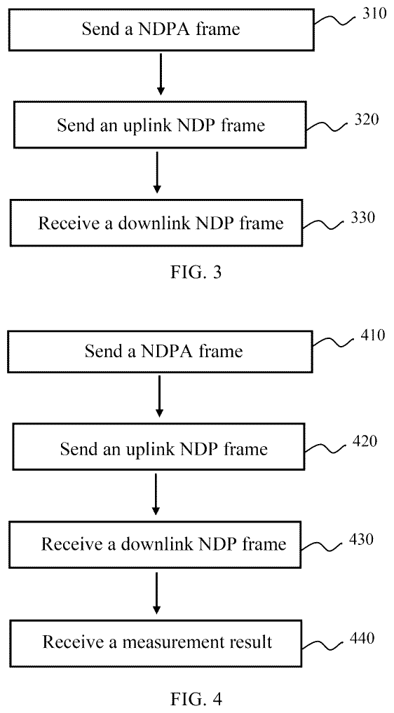

FIG. 3 shows a flowchart of a communication method according to an exemplary embodiment. The communication method shown in FIG. 3 may be performed by a WLAN sensing initiator (STA) and includes steps 310-330.

Referring to FIG. 3, in step 310, an NDPA frame may be sent; in step 320, an uplink NDP frame may be sent; and in step 330, a downlink NDP frame may be received. According to an embodiment of the present disclosure, one of the uplink NDP frame and the downlink NDP frame is a measurement NDP frame used for WLAN sensing measurement, the other of the uplink NDP frame and the downlink NDP frame is a non-measurement NDP frame not used for WLAN sensing measurement, and the measurement NDP frame and the non-measurement NDP frame may be of different operation parameters or formats.

For example, when only uplink sounding is performed, the uplink NDP frame may be a measurement NDP frame used for WLAN sensing measurement, and the downlink NDP frame may be a non-measurement NDP frame not used for WLAN sensing measurement. Further, when only downlink sounding is performed, the downlink NDP frame may be a measurement NDP frame, and the uplink NDP frame may be a non-measurement NDP frame. To save overhead (e.g., to save overhead for transmitting non-measurement NDP frames as much as possible), different operation parameters or formats may be adopted for the measurement NDP frame and the non-measurement NDP frame.

According to an embodiment of the present disclosure, an operation parameter of the non-measurement NDP frame may include: a number of first spatial streams (NSS) and a first operation bandwidth (BW) of the non-measurement NDP frame; a format of the non-measurement NDP frame may represent information included in the non-measurement NDP frame, and the non-measurement NDP frame may include: a first long training field (LTF). A number of the first long training field and the first operation bandwidth of the non-measurement NDP frame may be fixed and carried in the NDPA frame, or determined in a WLAN sensing measurement setup stage, for example, the number of the first LTF is 1, and the first operation bandwidth is 20 MHz.

According to an embodiment of the present disclosure, the operation parameter of the measurement NDP frame may include: a number of second spatial streams, and a second operation bandwidth of the measurement NDP frame; a format of the measurement NDP frame may represent information included in the measurement NDP frame, and the measurement NDP frame may include: a second long training field, and a packet extension (PE) field. The number of the second long training field of the measurement NDP frame and the second operation bandwidth may be carried in the NDPA frame, or determined in the WLAN sensing measurement setup stage. Further, the number of the second long training field of the measurement NDP frame and the second operation bandwidth are different for different WLAN sensing measurement events.

However, it shall be understood that the operation parameter and format (including information) of the measurement NDP frame and the non-measurement NDP frame described herein are merely exemplary, and the present disclosure is not limited thereto, for example, the operation parameter of the measurement NDP frame and the non-measurement NDP frame may include various channel parameters for transmitting the measurement NDP frame and the non-measurement NDP frame, and the format of the measurement NDP frame and the non-measurement NDP frame may represent various information carried by the measurement NDP frame and the non-measurement NDP frame.

For the operation parameter of the non-measurement NDP frame, in a case in which only uplink sounding is performed, the non-measurement NDP frame serves to identify that the AP receives the NDPA frame and the NDP frame sent by the STA, and in a case in which only downlink sounding is performed, the non-measurement NDP frame serves to identify integrity of an entire Non-TB sensing measurement procedure, so that sending overheads of the non-measurement NDP frame need to be reduced as much as possible. For example, the number of the first long training field (LTF) may have a correspondence with the first NSS, and in a case of the non-measurement NDP frame, the first NSS may be 1 (NSS=1), identifying only one LTF. That is, the number of the first long training field may be 1. In addition, since the non-measurement NDP frame carries less information, the non-measurement NDP frame can be transmitted in a basic BW 20 MHz channel. That is, the first operation bandwidth may be the basic 20 MHz bandwidth. However, the present disclosure is not limited thereto, and the first operation bandwidth for transmitting the non-measurement NDP frame may be equal to the second operation bandwidth for transmitting the measurement NDP frame (the second operation bandwidth will be described in detail later). In addition, to save sending overheads of the non-measurement NDP frame, the operation parameter of the NDP frame may not include the PE, or the PE may not be included in the NDP frame.

As a non-limiting exemplary embodiment of the present disclosure, the non-measurement NDP frame may have a format as shown in Table 1 or Table 2 below.

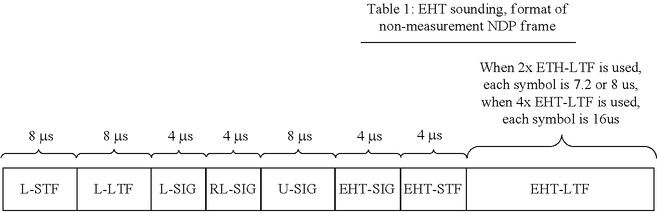

Table 1 shows a format of a non-measurement NDP frame in an extreme high-throughput (EHT) communication environment, for example, a number of the long training field (EHT-LTF) of the non-measurement NDP frame (that is, a number of the first long training field) is 1, and the PE is not included. In addition, the non-measurement NDP frame shown in Table 1 may further include: a legacy short training field (L-STF), a legacy long training field (L-LTF), a legacy signaling field (L-SIG), a repeated legacy signaling field (RL-SIG), a universal signaling field (U-SIG), an EHT signaling field (EHT-SIG), an EHT short training field (EHT-STF), and the like, which is only exemplary and the present disclosure is not limited thereto.

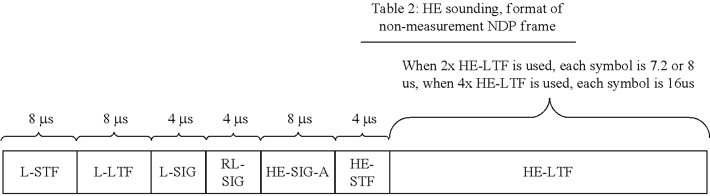

Table 2 shows a format of a non-measurement NDP frame in a high efficiency (HE) communication environment, for example, a number of the long training field (HE-LTF) of the non-measured NDP frame (that is, a number of the first long training field) is 1, and the PE is not included. In addition, the non-measurement NDP frame shown in Table 2 may further include: a legacy short training field (L-STF), a legacy long training field (L-LTF), a legacy signaling field (L-SIG), a repetition legacy signaling field (RL-SIG), an HE signaling field (HE-SIG-A), and an HE short training field (HE-STF), etc. However, this is merely an example, and the present disclosure is not limited thereto.

Regarding the operation parameter of the measurement NDP frame, since the measurement NDP frame is used for WLAN sensing measurement (i.e., as a WLAN sensing frame), an overhead of transmitting the measurement NDP frame may be greater than an overhead of transmitting the non-measurement NDP frame.

For example, a maximum number of LTFs (i.e., the number of the second long training fields) in the measurement NDP frame may be a maximum number of spatial streams supported by the transmitter of the measurement NDP frame (i.e., the maximum number of second spatial streams described herein). In an embodiment of the present disclosure, the maximum number of second spatial streams may be predetermined (obtained), for example, obtained before the communication method shown in FIG. 3 is performed. According to an embodiment of the present disclosure, the maximum number of second spatial streams may be obtained from a physical layer (PHY) capability information element. For example, the maximum number of second spatial streams may be obtained from an HE PHY capability information element or an EHT PHY capability information element, and for brevity, a specific format of the HE PHY capability information element or the EHT PHY capability information element is omitted herein.

Further, the number of LTFs in the measurement NDP frame (i.e., the number of second long training fields) may be associated with the second operation bandwidth of the measurement NDP frame. For example, but not limited to, when the second operation bandwidth of the measurement NDP frame is 20 MHz, 40 MHz, 80 MHz, or 160 MHz, the maximum number of the second long training filed may be 8; when the second operation bandwidth of the measurement NDP frame is 320 MHz, the maximum number of the second long training field may be 16.

Further, the packet extension field in the measurement NDP frame may be associated with the second operation bandwidth of the measurement NDP frame. For example, a length of the packet extension field in the case that the second operation bandwidth of the measurement NDP frame is 320 MHz may be greater than a length of the packet extension field in the case that the second operation bandwidth of the measurement NDP frame is 20 MHz, 40 MHZ, 80 MHz or 160 MHz, however, the present disclosure is not limited thereto, and the two may also be the same. In an embodiment of the present disclosure, the length of the packet extension field may identify a time taken to transmit the packet extension field (PE) in the measurement NDP frame, which will be described in detail later with reference to Table 3 and Table 4.

As a non-limiting exemplary embodiment of the present disclosure, the measurement NDP frame may have a format as shown in Table 3 or Table 4 below.

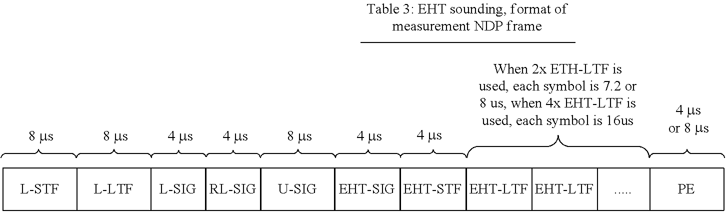

Table 3 shows a format of the measurement NDP frame in an EHT communication environment, for example, a number of long training fields (EHT-LTFs) of the measurement NDP frame (that is, a number of the second long training fields) may be multiple (for example, may be at most 16), and may include a PE of 4 us or 8 us. In addition, the measurement NDP frame shown in Table 3 may further include: an L-STF, an L-LTF, an L-SIG, an RL-SIG, a U-SIG, an EHT-SIG, and an EHT-STF. However, these are only exemplary, and the present disclosure is not limited thereto.

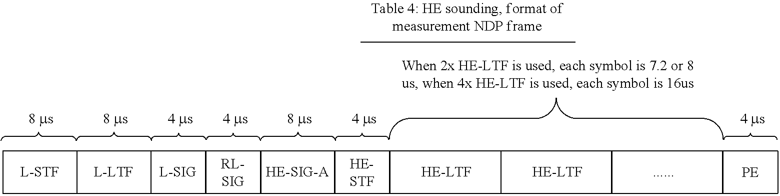

Table 4 shows a format of the measurement NDP frame in an HE communication environment, for example, a number of long training fields (HE-LTFs) of the measurement NDP frame (that is, a number of the second long training fields) is 8, and may include a PE of 4 us. In addition, the measurement NDP frame shown in Table 4 may further include: an L-STF, an L-LTF, an L-SIG, an RL-SIG, a HE-SIG-A and an HE-STF. However, these are only exemplary, and the present disclosure is not limited thereto.

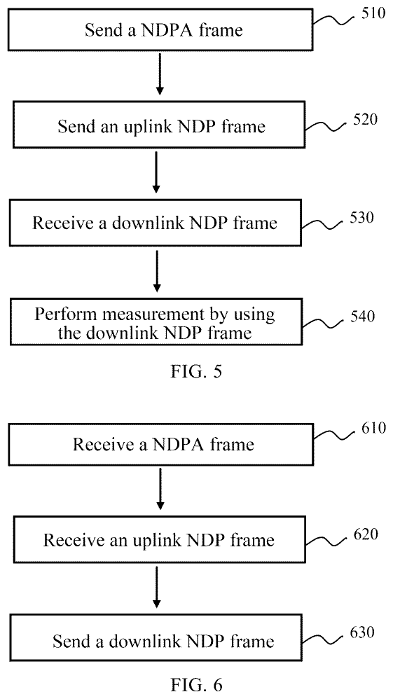

It can be understood that the communication method shown in FIG. 3 is merely exemplary, and the present disclosure is not limited thereto. For example, in FIGS. 4 and 5 embodiments of a communication method performed by an initiator (STA) are described.

FIG. 4 shows a flowchart of a communication method performed by an initiator (STA) in an uplink sounding according to an exemplary embodiment and includes steps 410-440.

In FIG. 4, steps 410 to 430 may be similar to steps 310 to 330 of FIG. 3, and repeated descriptions are omitted herein for brevity. When only uplink sounding is performed, the uplink NDP frame in step 420 is a measurement NDP frame, and the downlink NDP frame in step 430 is a non-measurement NDP frame.

According to an embodiment of the present disclosure, an operation parameter or a format of the uplink NDP frame may be different from an operation parameter or a format of the downlink NDP frame.

For example, the operation parameter of the uplink NDP frame may include: a number of second spatial streams and a second operation bandwidth of the uplink NDP frame; a format of the uplink NDP frame may indicate information included in the uplink NDP frame, and the uplink NDP frame may include a second long training field and a packet extension field. Specifically, a maximum number of the second long training field may be a maximum number of second spatial streams supported by the transmitter of the uplink NDP frame. The second operation bandwidth may be 20 MHz, 40 MHz, 80 MHZ, 160 MHZ, or 320 MHz. For example, when the second operation bandwidth of the uplink NDP frame is 20 MHz, 40 MHz, 80 MHZ, or 160 MHz, the maximum number of the second long training filed may be 8; when the second operation bandwidth of the uplink NDP frame is 320 MHz, the maximum number of the second long training field may be 16. In addition, a length of the packet extension field in the case that the second operation bandwidth of the uplink NDP frame is 320 MHz may be greater than a length of the packet extension field in the case that the second operation bandwidth of the uplink NDP frame is 20 MHz, 40 MHz, 80 MHz or 160 MHz, however, the present disclosure is not limited thereto, and the two may also be the same. However, the present disclosure is not limited thereto, for example, the uplink NDP frame may have an operation parameter or a format of a conventional NDP frame used for WLAN sensing measurement, or the embodiments of the measurement NDP frame described herein with reference to Table 3 and Table 4 may be applied to the uplink NDP frame herein, and repeated descriptions are omitted herein for brevity.

For example, the operation parameter of the downlink NDP frame may include a number of first spatial streams and a first operation bandwidth of the downlink NDP frame; a format of the downlink NDP frame may represent information included in the downlink NDP frame, and the downlink NDP frame may include a first long training field. Specifically, the number of first spatial streams and a number of the first long training fields may be 1, and the first operation bandwidth may be 20 MHz. However, the present disclosure is not limited thereto, for example, the downlink NDP frame may have an operation parameter or a format of a conventional NDP frame, or the embodiments of the non-measurement NDP frame described herein with reference to Table 1 and Table 2 may be applied to the downlink NDP frame herein, and repeated descriptions are omitted herein for brevity.

In addition, in the uplink sounding of FIG. 4, the initiator (STA) may receive a WLAN sensing measurement result (step 440). In other words, the receiver (AP) may perform WLAN sensing measurement based on the uplink NDP frame, and feedback a measurement result to the initiator, for example, but not limited to, channel state information (CSI).

FIG. 5 shows a flowchart of a communication method performed by an initiator (STA) in a downlink sounding according to an exemplary embodiment and includes steps 510-540.

In FIG. 5, steps 510 to 530 may be similar to steps 310 to 330 of FIG. 3, and repeated descriptions are omitted herein for brevity. When only downlink sounding is performed, the uplink NDP frame in step 520 is a non-measurement NDP frame, and the downlink NDP frame in step 530 is a measurement NDP frame.

According to an embodiment of the present disclosure, an operation parameter or a format of the uplink NDP frame may be different from an operation parameter or a format of the downlink NDP frame.

For example, the operation parameter of the uplink NDP frame may include: a number of first spatial streams and a first operation bandwidth of the uplink NDP frame; a format of the uplink NDP frame may represent information included in the uplink NDP frame, and the uplink NDP frame may include a first long training field. Specifically, the number of first spatial streams and a number of the first long training fields may be 1, and the first operation bandwidth may be 20 MHz. However, the present disclosure is not limited thereto, for example, the uplink NDP frame may have an operation parameter or a format of a conventional NDP frame, or the embodiments of the non-measurement NDP frame described herein with reference to Table 1 and Table 2 may be applied to the uplink NDP frame herein, and repeated descriptions are omitted herein for brevity.

For example, the operation parameter of the downlink NDP frame may include: a number of second spatial streams and a second operation bandwidth of the downlink NDP frame; a format of the downlink NDP frame may indicate information included in the downlink NDP frame, and the downlink NDP frame may include a second long training field and a packet extension field. Specifically, a maximum number of the second long training field may be a maximum number of second spatial streams supported by the transmitter of the downlink NDP frame. The second operation bandwidth may be 20 MHz, 40 MHZ, 80 MHz, 160 MHZ, or 320 MHz. For example, when the second operation bandwidth of the downlink NDP frame is 20 MHz, 40 MHZ, 80 MHZ, or 160 MHz, the maximum number of the second long training filed may be 8; when the second operation bandwidth of the downlink NDP frame is 320 MHz, the maximum number of the second long training field may be 16. In addition, a length of the packet extension field in the case that the second operation bandwidth of the downlink NDP frame is 320 MHz may be greater than a length of the packet extension field in the case that the second operation bandwidth of the downlink NDP frame is 20 MHz, 40 MHz, 80 MHz or 160 MHz, however, the present disclosure is not limited thereto, and the two may also be the same. However, the present disclosure is not limited thereto, for example, the downlink NDP frame may have an operation parameter or a format of a conventional NDP frame used for WLAN sensing measurement, or the embodiments of the measurement NDP frame described herein with reference to Table 3 and Table 4 may be applied to the downlink NDP frame herein, and repeated descriptions are omitted herein for brevity.

In addition, in the downlink sounding of FIG. 5, the initiator (STA) may directly use the downlink NDP frame to perform the WLAN sensing measurement result (step 540) without receiving the measurement result from the responder (AP).

FIG. 6 shows a flowchart of another communication method according to an exemplary embodiment. The communication method shown in FIG. 6 may be performed by a responder (AP) and includes steps 610-630.

Referring to FIG. 6, in step 610, an NDPA frame may be received; in step 620, an uplink NDP frame may be received; and in step 630, a downlink NDP frame may be sent. One of the uplink NDP frame and the downlink NDP frame may be a measurement NDP frame used for WLAN sensing measurement, the other of the uplink NDP frame and the downlink NDP frame may be a non-measurement NDP frame not used for WLAN sensing measurement, and the measurement NDP frame and the non-measurement NDP frame are of different operation parameters or formats.

According to an embodiment of the present disclosure, the operation parameter of the non-measurement NDP frame may include: a number of first spatial streams, and a first operation bandwidth of the non-measurement NDP frame; a format of the non-measurement NDP frame may represent information included in the non-measurement NDP frame, and the non-measurement NDP frame may include: a first long training field. According to an embodiment of the present disclosure, the operation parameter of the measurement NDP frame may include: a number of second spatial streams, and a second operation bandwidth of the measurement NDP frame; a format of the measurement NDP frame may represent information included in the measurement NDP frame, and the measurement NDP frame includes: a second long training field, and a packet extension field.

According to an embodiment of the present disclosure, the number of first spatial streams and the number of first long training domains may be 1.

According to an embodiment of the present disclosure, the first operation bandwidth may be 20 MHz, or the first operation bandwidth may be equal to the second operation bandwidth.

According to an embodiment of the present disclosure, a maximum number of the second long training field may be a maximum number of second spatial streams supported by the transmitter of the measurement NDP frame. The maximum number of second spatial streams may be obtained from the physical layer capability information element.

According to an embodiment of the present disclosure, when the second operation bandwidth of the measurement NDP frame is 20 MHz, 40 MHz, 80 MHZ, or 160 MHz, the maximum number of the second long training filed may be 8; when the second operation bandwidth of the measurement NDP frame is 320 MHz, the maximum number of the second long training field may be 16.

According to an embodiment of the present disclosure, a length of the data packet extension field when the second operation bandwidth of the measurement NDP frame is 320 MHz may be greater than a length of the data packet extension field when the second operation bandwidth of the measurement NDP frame is 20 MHz, 40 MHz, 80 MHz or 160 MHz. However, the present disclosure is not limited thereto, and the two may also be equal.

According to an embodiment of the present disclosure, the number of the first long training field of the non-measurement NDP frame and the first operation bandwidth may be fixed and carried in the NDPA frame, or determined in the WLAN sensing measurement setup stage.

According to an embodiment of the present disclosure, the number of the second long training field of the measurement NDP frame and the second operation bandwidth may be carried in the NDPA frame, or determined in the WLAN sensing measurement setup stage.

According to an embodiment of the present disclosure, the number of the second long training field of the measurement NDP frame and the second operation bandwidth may be different for different WLAN sensing measurement events.

Embodiments of the non-measurement NDP frame and the measurement NDP frame described herein with reference to FIG. 3 and Tables 1 to 4 may be applied thereto, and repeated descriptions are omitted herein for brevity.

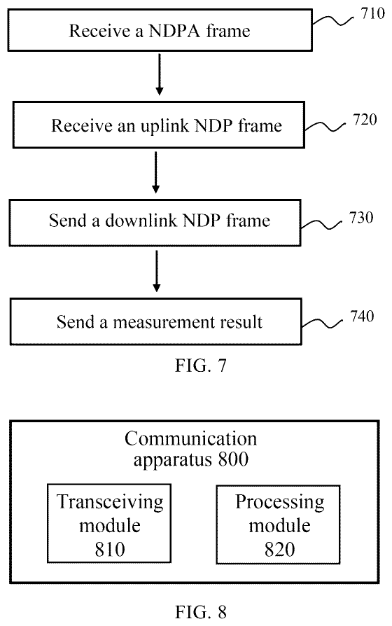

It can be understood that the communication method shown in FIG. 6 is merely exemplary, and the present disclosure is not limited thereto. For example, in FIG. 7, embodiments of a communication method performed by a responder (AP) are described.

FIG. 7 shows a flowchart of a communication method performed by a responder (AP) in an uplink sounding according to an exemplary embodiment and includes steps 710-740.

In FIG. 7, steps 710 to 730 may be similar to steps 610 to 630 of FIG. 6, and repeated descriptions are omitted herein for brevity. When only uplink sounding is performed, the uplink NDP frame in step 720 is a measurement NDP frame, and the downlink NDP frame in step 730 is a non-measurement NDP frame.

According to an embodiment of the present disclosure, an operation parameter or a format of the uplink NDP frame may be different from an operation parameter or a format of the downlink NDP frame.

For example, the operation parameter of the uplink NDP frame may include: a number of second spatial streams and a second operation bandwidth of the uplink NDP frame; a format of the uplink NDP frame may indicate information included in the uplink NDP frame, and the uplink NDP frame may include a second long training field and a packet extension field. Specifically, a maximum number of the second long training field may be a maximum number of second spatial streams supported by the transmitter of the uplink NDP frame. The second operation bandwidth may be 20 MHz, 40 MHz, 80 MHz, 160 MHz, or 320 MHz. For example, when the second operation bandwidth of the uplink NDP frame is 20 MHz, 40 MHZ, 80 MHz, or 160 MHz, the maximum number of the second long training filed may be 8; when the second operation bandwidth of the uplink NDP frame is 320 MHZ, the maximum number of the second long training field may be 16. In addition, a length of the packet extension field in the case that the second operation bandwidth of the uplink NDP frame is 320 MHz may be greater than a length of the packet extension field in the case that the second operation bandwidth of the uplink NDP frame is 20 MHz, 40 MHz, 80 MHz or 160 MHz, however, the present disclosure is not limited thereto, and the two may also be the same. However, the present disclosure is not limited thereto, for example, the uplink NDP frame may have an operation parameter or a format of a conventional NDP frame used for WLAN sensing measurement, or the embodiments of the measurement NDP frame described herein with reference to Table 3 and Table 4 may be applied to the uplink NDP frame herein, and repeated descriptions are omitted herein for brevity.

For example, the operation parameter of the downlink NDP frame may include a number of first spatial streams and a first operation bandwidth of the downlink NDP frame; a format of the downlink NDP frame may represent information included in the downlink NDP frame, and the downlink NDP frame may include a first long training field. Specifically, the number of first spatial streams and a number of the first long training fields may be 1, and the first operation bandwidth may be 20 MHz. However, the present disclosure is not limited thereto, for example, the downlink NDP frame may have an operation parameter or a format of a conventional NDP frame, or the embodiments of the non-measurement NDP frame described herein with reference to Table 1 and Table 2 may be applied to the downlink NDP frame herein, and repeated descriptions are omitted herein for brevity.

In addition, in the uplink sounding of FIG. 7, the responder (AP) may perform WLAN sensing measurement based on the uplink NDP frame received in step 720, and transmit a WLAN sensing measurement result (e.g., channel state information (CSI)) to the initiator (STA) (step 740).

The flowchart of the communication method performed by the responder (AP) when performing downlink sounding may be similar to FIG. 6, that is, the responder (AP) may send a downlink NDP frame (measurement NDP frame) for WLAN sensing measurement without performing WLAN sensing measurement. When only downlink sounding is performed, the uplink NDP frame is a non-measurement NDP frame, and the downlink NDP frame is a measurement NDP frame. According to an embodiment of the present disclosure, an operation parameter or a format of the uplink NDP frame may be different from an operation parameter or a format of the downlink NDP frame.

For example, the operation parameter of the uplink NDP frame may include: a number of first spatial streams and a first operation bandwidth of the uplink NDP frame; a format of the uplink NDP frame may represent information included in the uplink NDP frame, and the uplink NDP frame may include a first long training field. Specifically, the number of first spatial streams and a number of the first long training fields may be 1, and the first operation bandwidth may be 20 MHz. However, the present disclosure is not limited thereto, for example, the uplink NDP frame may have an operation parameter or a format of a conventional NDP frame, or the embodiments of the non-measurement NDP frame described herein with reference to Table 1 and Table 2 may be applied to the uplink NDP frame herein, and repeated descriptions are omitted herein for brevity.

For example, the operation parameter of the downlink NDP frame may include: a number of second spatial streams and a second operation bandwidth of the downlink NDP frame; a format of the downlink NDP frame may indicate information included in the downlink NDP frame, and the downlink NDP frame may include a second long training field and a packet extension field. Specifically, a maximum number of the second long training field may be a maximum number of second spatial streams supported by the transmitter of the downlink NDP frame. The second operation bandwidth may be 20 MHz, 40 MHz, 80 MHZ, 160 MHz, or 320 MHz. For example, when the second operation bandwidth of the downlink NDP frame is 20 MHz, 40 MHZ, 80 MHZ, or 160 MHz, the maximum number of the second long training filed may be 8; when the second operation bandwidth of the downlink NDP frame is 320 MHz, the maximum number of the second long training field may be 16. In addition, a length of the packet extension field in the case that the second operation bandwidth of the downlink NDP frame is 320 MHz may be greater than a length of the packet extension field in the case that the second operation bandwidth of the downlink NDP frame is 20 MHz, 40 MHz, 80 MHz or 160 MHz, however, the present disclosure is not limited thereto, and the two may also be the same. However, the present disclosure is not limited thereto, for example, the downlink NDP frame may have an operation parameter or a format of a conventional NDP frame used for WLAN sensing measurement, or the embodiments of the measurement NDP frame described herein with reference to Table 3 and Table 4 may be applied to the downlink NDP frame herein, and repeated descriptions are omitted herein for brevity.

In the communication method described with reference to FIG. 3 to FIG. 7, a Non-TB based sensing measurement manner is improved, different operation parameters of a measurement NDP frame and a non-measurement NDP frame are defined, and overheads of the non-measurement NDP frame are reduced as much as possible, so as to better adapt to WLAN sensing measurement.

FIG. 8 shows a block diagram of a communication apparatus according to an exemplary embodiment. The communication apparatus 800 in FIG. 8 may include a processing module 820 (such as a processor) and a transceiving module 810 (such as a transceiver or input/output device “I/O”). In an embodiment of the present disclosure, the communication apparatus 800 shown in FIG. 8 may be applied to an initiator (STA); in another embodiment of the present disclosure, the communication apparatus 800 shown in FIG. 8 may be applied to a responder (AP).

When the communication apparatus 800 shown in FIG. 8 may be applied to an initiator (STA), the processing module 820 may be configured to: control overall operations of the communication apparatus 800 (for example, control sending of an NDPA frame and an NDP frame, execution of WLAN sensing measurement, and the like); and the transceiving module 810 may be configured to: send a null data packet announcement (NDPA) frame, send an uplink null data packet (NDP) frame, and receive a downlink NDP frame, where one of the uplink NDP frame and the downlink NDP frame may be a measurement NDP frame used for WLAN sensing measurement, and another of the uplink NDP frame and the downlink NDP frame may be a non-measurement NDP frame not used for WLAN sensing measurement, and the measurement NDP frame and the non-measurement NDP frame may be of different operation parameters and formats. That is, the communication apparatus 800 shown in FIG. 8 may perform the communication method described with reference to FIG. 3 to FIG. 5, and the embodiments described with reference to Table 1 to Table 4 may be applied thereto, and in order to avoid redundancy, repeated descriptions are omitted herein.

When the communication apparatus 800 shown in FIG. 8 may be applied to a responder (AP), the transceiving module 810 may be configured to: receive a null data packet announcement (NDPA) frame, receive an uplink null data packet (NDP) frame, and send a downlink NDP frame, where one of the uplink NDP frame and the downlink NDP frame may be a measurement NDP frame used for WLAN sensing measurement, and another one of the uplink NDP frame and the downlink NDP frame may be a non-measurement NDP frame not used for WLAN sensing measurement, and the measurement NDP frame and the non-measurement NDP frame are of different operation parameters and formats; and the processing module 820 may be configured to: control overall operations of the communication apparatus 800 (for example, control sending of the NDPA frame and the NDP frame, execution of the WLAN sensing measurement, and the like). That is, the communication apparatus 800 shown in FIG. 8 may perform the communication method described with reference to FIG. 6 to FIG. 7, and the embodiments described with reference to Table 1 to Table 4 may be applied thereto, and in order to avoid redundancy, repeated descriptions are omitted herein.

It will be understood that the communication apparatus 800 shown in FIG. 8 is merely exemplary, and the embodiments of the present disclosure are not limited thereto, for example, the communication apparatus 800 may further include other modules, such as a memory module (not shown). In addition, various modules in the communication apparatus 800 may be combined into a more complex module, or may be divided into more separate modules.

The communication method and the communication apparatus according to the embodiments of the present disclosure define different operation parameters of the measurement NDP frame and the non-measurement NDP frame, and reduce the overhead of the non-measurement NDP frame as much as possible, which can better adapt to WLAN sensing measurement.

Based on the same principle as the method provided by the embodiments of the present disclosure, the embodiments of the present disclosure further provide an electronic device including a processor and a memory, where the memory stores machine-readable instructions (which may also be referred to as “computer programs”); and the processor is configured to execute the machine-readable instructions to implement the method described with reference to FIG. 3 to FIG. 7.

An embodiment of the present disclosure further provides a non-transitory computer-readable storage medium, where the non-transitory computer-readable storage medium stores a computer program, and when the computer program is executed by a processor, the method described with reference to FIG. 3 to FIG. 7 is implemented.

In an example embodiment, the processing module 820 may be a processor configured to implement or execute various example logical blocks, modules, and circuits described in connection with the present disclosure, for example, a central processing unit (CPU), a general purpose processor, a digital signal processor (DSP), an application specific integrated circuit (ASIC), a field programmable gate array (FPGA) or another programmable logic device, a transistor logic device, a hardware component, or any combination thereof. The processor may alternatively be a combination that implements a computing function, for example, a combination that includes one or more microprocessors, or a combination of a digital signal processing (DSP) and a microprocessor.

In an exemplary embodiment, the memory module (not shown) may be a memory, for example, a ROM (Read Only Memory), a RAM (Random Access Memory), an EEPROM (Electrically Erasable Programmable Read Only Memory), a CD-ROM (Compact Disk Read Only Memory) or other optical disk storage, optical disk storage (including a compact optical disk, a laser disk, an optical disk, a digital versatile disk, a Blu-ray optical disk, etc.), a magnetic disk storage medium or other magnetic storage devices, or any other medium that can be used to carry or store program code in a form of an instruction or a data structure and that can be accessed by a computer, but is not limited thereto.

It should be understood that although the steps in the flowchart of the accompanying drawings are sequentially shown as indicated by arrows, these steps are not necessarily sequentially performed in the order indicated by the arrows. Unless explicitly stated herein, the execution of these steps is not strictly limited in order and may be performed in other orders. In addition, at least a part of steps in the flowchart of the accompanying drawings may include a plurality of sub-steps or a plurality of stages, and these sub-steps or stages are not necessarily performed at the same moment, but may be performed at different moments, and an execution sequence of the sub-steps or stages is not necessarily performed sequentially, but may be performed alternately or alternately with at least a part of the sub-steps or stages of other steps or other steps.

While the present disclosure has been shown and described with reference to certain embodiments thereof, it will be understood by those skilled in the art that various changes may be made in form and detail without departing from the scope of the present disclosure. Accordingly, the scope of the present disclosure should not be limited to embodiments, but should be defined by the appended claims and their equivalents.

1. A communication method, comprising:
sending a null data packet announcement (NDPA) frame;
sending an uplink null data packet (NDP) frame; and
receiving a downlink NDP frame,
wherein one of the uplink NDP frame and the downlink NDP frame is a measurement NDP frame used for wireless local area network sensing measurement, and another one of the uplink NDP frame and the downlink NDP frame is a non-measurement NDP frame not used for the wireless local area network sensing measurement, and
wherein the measurement NDP frame and the non-measurement NDP frame are of different operation parameters or formats.

2. The communication method according to claim 1, wherein at least one of:
an operation parameter of the non-measurement NDP frame comprises: a number of first spatial streams and a first operation bandwidth of the non-measurement NDP frame; a format of the non-measurement NDP frame represents information comprised in the non-measurement NDP frame, and the non-measurement NDP frame comprises a first long training field; or
an operation parameter of the measurement NDP frame comprises: a number of second spatial streams and a second operation bandwidth of the measurement NDP frame; a format of the measurement NDP frame represents information comprised in the measurement NDP frame, and the measurement NDP frame comprises a second long training field and a packet extension field.

3. The communication method according to claim 2, wherein the number of first spatial streams is 1, and a number of the first long training field is 1.

4. The communication method according to claim 2, wherein the first operation bandwidth is 20 MHz, or the first operation bandwidth is equal to the second operation bandwidth.

5. The communication method according to claim 2, wherein a maximum number of the second long training field is a maximum number of the second spatial streams supported by a transmitter of the measurement NDP frame.

6. The communication method according to claim 5, wherein
the maximum number of the second spatial streams is acquired from a physical layer capability information element.

7. The communication method according to claim 2, wherein
when the second operation bandwidth of the measurement NDP frame is 20 MHz, 40 MHz, 80 MHz or 160 MHz, a maximum number of the second long training field is 8 and
when the second operation bandwidth of the measurement NDP frame is 320 MHz, the maximum number of the second long training field is 16.

8. The communication method according to claim 2, wherein a length of the packet extension field when the second operation bandwidth of the measurement NDP frame is 320 MHz is greater than a length of the packet extension field when the second operation bandwidth of the measurement NDP frame is 20 MHz, 40 MHZ, 80 MHz or 160 MHz.

9. The communication method according to claim 2, wherein a number of the first long training field and a number of the first operation bandwidth of the non-measurement NDP frame are either
fixed and carried in the NDPA frame, or
determined in a setup stage of the wireless local area network sensing measurement.

10. The communication method according to claim 2, wherein a number of the second long training field and a number of the second operation bandwidth of the measurement NDP frame are either
carried in the NDPA frame, or
determined in a setup stage of the wireless local area network sensing measurement.

11. The communication method according to claim 2, wherein a number of the second long training field and a number of the second operation bandwidth of the measurement NDP frame are different for different wireless local area network sensing measurement events.

12. A communication method, comprising:
receiving a null data packet announcement (NDPA) frame;
receiving an uplink null data packet (NDP) frame; and
sending a downlink NDP frame,
wherein one of the uplink NDP frame and the downlink NDP frame is a measurement NDP frame used for wireless local area network sensing measurement, and another one of the uplink NDP frame and the downlink NDP frame is a non-measurement NDP frame not used for the wireless local area network sensing measurement, and
wherein the measurement NDP frame and the non-measurement NDP frame are of different operation parameters or formats.

13. The communication method according to claim 11, wherein at least one of:
an operation parameter of the non-measurement NDP frame comprises: a number of first spatial streams and a first operation bandwidth of the non-measurement NDP frame; a format of the non-measurement NDP frame represents information comprised in the non-measurement NDP frame, and the non-measurement NDP frame comprises a first long training field; or
an operation parameter of the measurement NDP frame comprises: a number of second spatial streams and a second operation bandwidth of the measurement NDP frame; a format of the measurement NDP frame represents information comprised in the measurement NDP frame, and the measurement NDP frame comprises a second long training field and a packet extension field.

14. The communication method according to claim 13, wherein the number of first spatial streams is 1, and a number of the first long training field is 1.

15. The communication method according to claim 13, wherein the first operation bandwidth is 20 MHz, or the first operation bandwidth is equal to the second operation bandwidth.

16. The communication method according to claim 13, wherein a maximum number of the second long training field is a maximum number of the second spatial streams supported by a transmitter of the measurement NDP frame.

17.-22. (canceled)

23. A communication apparatus, comprising:
a memory-storing a computer program;
an input/output device; and
a processor-communicatively coupled to the memory and the input/output device, and when the processor executes the computer program, the processor is configured to:
send a null data packet announcement (NDPA) frame,
send an uplink null data packet (NDP) frame, and
receive a downlink NDP frame,
wherein one of the uplink NDP frame and the downlink NDP frame is a measurement NDP frame used for wireless local area network sensing measurement, and another one of the uplink NDP frame and the downlink NDP frame is a non-measurement NDP frame not used for the wireless local area network sensing measurement, and
wherein the measurement NDP frame and the non-measurement NDP frame are of different operation parameters or formats.

24. A communication apparatus, comprising:
a memory storing a computer program;
an input/output device; and
a processor communicatively coupled to the memory and the input/output device, and when the processor executes the computer program, the communication method according to claim 12 is implemented.

25. (canceled)

26. A non-transitory computer-readable storage medium,
wherein a computer program is stored on the non-transitory computer-readable storage medium, and when the computer program is executed by a processor, the communication method according to claim 1 is implemented.

27. A non-transitory computer-readable storage medium, wherein a computer program is stored on the non-transitory computer-readable storage medium, and when the computer program is executed by a processor, the communication method according to claim 12 is implemented.
